(19) United States
(12) Patent Application Publication
(10) Pub. No.: US 2010/0161430 A1
(43) Pub. Date: Jun. 24, 2010

(54) SYSTEM AND METHOD FOR LIVE-INTERACTION CONTENT

(75) Inventor: Edward W. Mandel, Frisco, TX (US)

Correspondence Address: CARSTENS & CAHOON, LLP, P O BOX 802334, DALLAS, TX, 75380, US

(73) Assignee: NEXPLORE TECHNOLOGIES, INC., Frisco, TX (US)

(21) Appl. No.: 12/348,653

(22) Filed: Jan. 5, 2009

Related U.S. Application Data
(63) Continuation-in-part of application No. 12/340,195, filed on Dec. 19, 2008.

(51) Int. Cl. G06F 3/048; G06Q 30/00

(52) U.S. Cl. 705/14.73; 715/756; 715/808; 705/346

(57) ABSTRACT

A system and method provides live-interaction between a user and an advertiser or the advertiser's representative. An advertisement and a corresponding live interaction icon is displayed before a user. The user may select the icon to indicate a desire for additional information concerning the advertisement. Upon selection, the system initiates a video-conference session between the user and advertiser for the live exchange of information. During the session the advertiser may provide supplementary content, such as a video or electronic document, for display in the user's browser. The system consists of three dedicated modules that perform the aforementioned method steps.

### CROSS-REFERENCE TO RELATED APPLICATIONS

This application is a continuation-in-part of U.S. patent application Ser. No. 12/340,195, which was filed on Dec. 19, 2008.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

The present invention relates to web advertising services, and more specifically to live-interaction content rendering systems.

2. Description of Related Art Including Information Disclosed Under 37 CFR 1.97 and 1.98

The more quickly you can get a potential customer in contact with an advertiser, the greater the likelihood that the potential customer becomes a customer. Current solutions only provide a link to the website or perhaps a phone number or e-mail address in the ad. Or worse yet, require the potential customer to go to the advertiser's website to search for contact information.

At present, video-conferencing technology may be utilized to connect an advertiser and potential customer. However, leading video-conferencing products are very costly and typically not standard-based. This causes great disparity in the quality and compatibility of the various products.

Another current solution that may be utilized is real-time streaming. Real-time streaming of media allows users to play media as they receive it. This is especially useful when real-time interaction is desired. However, real-time streaming typically requires costly, dedicated streaming media servers using streaming protocols such as Real-Time Protocol (RTP). RTP is an Internet standard for transporting real-time data. Moreover, RTP allows playback only, and does not allow modification of the content being delivered.

The present invention derives technical advantages because other solutions do not allow real-time video conferencing with representatives associated with an advertisement. Moreover, other solutions do not allow the real-time modification of content delivery based on live-interaction with the representative via a video conferencing medium.

### BRIEF SUMMARY OF THE INVENTION

The present invention provides a method, system, and computer software for providing live-interaction content associated with an advertisement in a networked environment. A user searching the network for information is presented with an advertisement received from an advertiser. In proximity to the advertisement on the user's display is a live interaction icon that allows the user to indicate his or her desire for more information concerning the goods or services being advertised.

In response to the user's selection of the icon, the system accepts the request and initiates a video-conference session between the user and the advertiser or the advertiser's designated representative. As the user and the advertiser communicate via the session, the advertiser can provide additional content (such as an electronic document, image, or video) to assist in conveying information to the user. The system causes the additional content to be displayed before the user in the user's browser or in an additional pop-up window.

In other embodiments, the system may determine if the advertiser or the designated representative is available. If not available, certain content is displayed in the user's browser until the advertiser or designated representative comes available. This certain content may be an advertising video or other graphic that provides additional detail to that provided in the initial advertisement. The system performing these method steps consists of an advertisement contact module, a video-conferencing module, and a content-rendering module.

### BRIEF DESCRIPTION OF THE SEVERAL VIEWS OF THE DRAWING(S)

The present invention will be more fully understood by reference to the following detailed description of the preferred embodiments of the present invention when read in conjunction with the accompanying drawings, wherein:

FIG. 1 exemplifies a diagram of a live-interaction content rendering system in a networked environment, in accordance with principles of the present invention;

FIG. 2 exemplifies a diagram of a method for providing live-interaction content, in accordance with principles of the present invention; and

FIG. 3 contains a screen shot of advertisements having a live-interaction content icon, in accordance with principles of the present invention.

The above figures are provided for the purpose of illustration and description only, and are not intended to define the limits of the disclosed invention. Use of the same reference number in multiple figures is intended to designate the same or similar parts. Furthermore, if and when the terms “top,” “bottom,” “first,” “second,” “upper,” “lower,” ““height,” “width,” “length,” end,” “side,” “horizontal,” “vertical,” and similar terms are used herein, it should be understood that these terms have reference only to the structure shown in the drawing and are utilized only to facilitate describing the particular embodiment. The extension of the figures with respect to number, position, relationship, and dimensions of the parts to form the preferred embodiment will be explained or will be within the skill of the art after the following teachings of the present invention have been read and understood.

### DETAILED DESCRIPTION OF THE INVENTION

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

In the following discussion, numerous specific details are set forth to provide a thorough understanding of the present invention. However, it will be obvious to those skilled in the art that the present invention may be practiced without such specific details. In other instances, well-known elements have been illustrated in schematic or block diagram form in order not to obscure the present invention in unnecessary detail. Additionally, for the most part, details concerning the Internet, digital content, and the like have been omitted inasmuch as such details are not considered necessary to obtain a complete understanding of the present invention, and are considered to be within the skills of persons of ordinary skill in the relevant art.

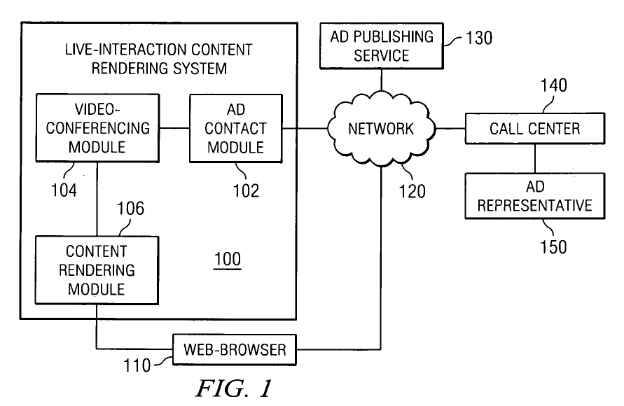

Referring to FIG. 1, there is shown a diagram of a live-interaction content rendering system (100) for providing live-interaction content associated with an advertisement over a network, in accordance with principles of the present invention. The system (100) is part of an application adapted to provide search results and advertisements associated with a search term. The application can be resident on a computer, a website, blog, forum, aggregator, and other suitable web-enabled application. The system (100) is preferably implemented in hardware, software, or a suitable combination of hardware and software thereof and may comprise one or more software systems operating on a digital signal processing platform or other suitable processing platforms.

As used herein, “hardware” can include a combination of discrete components, an integrated circuit, a microprocessor, a controller, a microcontroller, an application-specific integrated circuit (ASIC), an electronic data processor, a computer, a field programmable gate array, or other suitable hardware connectable for interfacing with a network, such as the Internet, considered to be well-known in the art. As used herein, “software” can include one or more objects, agents, threads, lines of code, subroutines, separate software applications, two or more lines of code or other suitable software structures operating in two or more software applications or on two or more processors, or other suitable hardware structures. Furthermore, it is considered that the design, development, and implementation details of all such hardware and software would be apparent to a person having ordinary skill in the art based upon a review of the present description of the invention. In one embodiment, software can include one or more lines of code or other suitable software structures operating in a general purpose software application, such as an operating system, and one or more lines of code or other suitable software structures operating in a specific purpose software application.

The system (100) is operably coupled to web-browser (110), advertisement publishing service (130), call center (140), and advertisement representative (150) by network (120). The network can be a WAN, MAN, LAN, PAN, and other suitable network. The system (100) is adapted to receive a communication request to provide live-interaction with a contact having information about an advertisement displayed in web-browser (110) or graphical user interface (GUI). With communication request, code is generated to instantiate a video-conference with the advertisement representative (150), of the call center (140), associated with the advertisement contact information. The system (100) in this embodiment includes an advertisement contact module (102), a video-conferencing module (104), and a content rendering module (106). The system (100) determines which representative to establish a video-conference with, instantiates the video-conference connection, and provides a medium for content rendering within the user's browser.

The advertisement contact module (102) is adapted to receive advertisements from the advertisement publishing service (130). Upon receipt, the module parses information contained in the advertisement. In one embodiment, the advertisements are received in an XML file. In a second embodiment, the advertisements are received in a JSON file. In a third embodiment, the advertisement information parsed is contact information for the advertiser. The contact information can include entries such as an advertisement identification number, a call center identification number, a call center representative identification number, and other suitable contact information. In a fourth embodiment, an advertisement can be assigned to a specific representative of a specific call center over a specific time period. The representative, call center, and time period can all be dynamically changed to accommodate workload. As used herein, the term “advertising representative” includes, but is not limited to, a designated call center, a third-party representative of an advertiser, or the advertiser itself. The advertisement contact module (102) can be achieved with an application programming interface (API), a network connection, a network transfer protocol, HTML, DHTML, JavaScript, Dojo, Ruby, Rails, other suitable formats and applications, or a suitable combination thereof.

The video-conferencing module (104) is adapted to establish a video-conferencing connection between the user and the ad representative (150) associated with an advertisement received from the advertisement publishing service (130). In one embodiment, the video-conference is established using a standards-based video-conferencing API. The video-conference is rendered in a first pop-up window, or in a region of the web-browser (110). In a second embodiment, the standard-based video-conferencing API is the Java Media Framework (JMF) API. In a third embodiment, the JMF API can be used to establish the audio, video, and other media conferencing. In a fourth embodiment, a JMF Server applet can capture audio and video, store the data in a buffer, and transmit the data to a JMF client applet as a Real-Time Protocol (RTP) stream. In a fifth embodiment, an audio codec, such as G.711 and G.722, a video codec, such as H.263 and H.264, and a transfer protocol, such as RTP, are utilized to instantiate a video-conference between the user and the ad representative (150). Although a video-conference is the preferred live-interaction method, the conference can also be established by sending video only to the user and not the ad representative, or by sending only audio. In a sixth embodiment, the user can receive streaming video and audio via the application and communicate with the ad representative (150) via one of the plurality of communication mechanisms or over the phone by calling the call center (140). The video-conferencing module (104) can be achieved with an application programming interface (API), a network connection, a network transfer protocol, a video codec, an audio codec, HTML, DHTML, Java, JavaScript, Dojo, Ruby, Rails, other suitable formats and applications, or a suitable combination thereof.

The content-rendering module (106) is adapted to render additional content to the user from the ad representative (150) associated with the advertisement received from the advertisement publishing service (130). In one embodiment, the additional content is displayed in the first pop-up window. In a second embodiment, the additional content is displayed in a second first pop-tip window. In a third embodiment, the additional content is displayed in the region of the web-browser (110).

In operation, a user sees an advertisement of interest. The user either mouses-over or selects a live-interaction content icon disposed proximate the ad of interest. The system (100) then establishes a video-conference with the call center (140) or the ad representative (150) listed in the ad's contact information. The ad representative (150) pops up in the first pop-up window, greets the user, provides information about the advertised product or service, and answers any questions the user may have about the product or service.

During the video-conference, the ad representative (150) may determine, by discussing the product or service advertised, that another product or service is better suited to the user's needs. The ad representative (150) may then transmit additional content—such as a video or audio commercial, brochure PDF, whitepaper document, web form, or other suitable digital content—for display in a second pop-up window for the user to evaluate or to complete and submit to the representative. Once the live-interaction session is completed, all pop-up windows close and the user can continue his search.

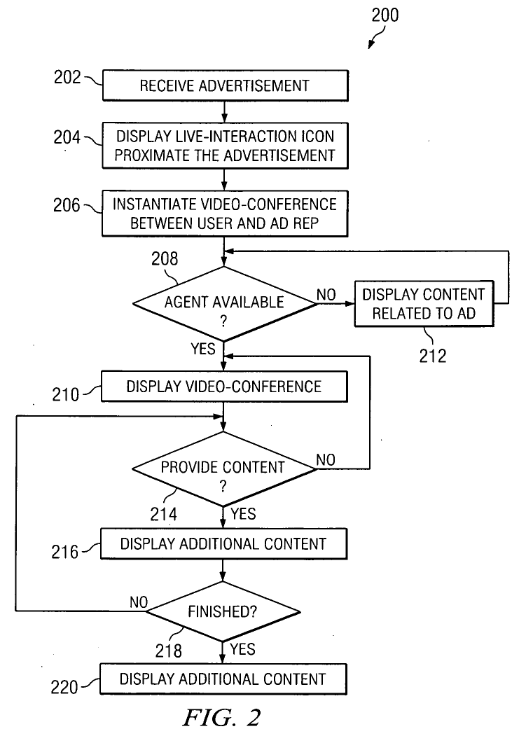

Referring now to FIG. 2, there is shown a flow chart (200) exemplifying control logic embodying features of a method for providing live-interaction content in accordance with principles of the present invention. The live-interaction content control logic (200) can be implemented as an algorithm on a general purpose computing platform or other suitable microprocessor-based system.

The live-interaction content control logic (200) can leverage the ability of a computer platform to spawn multiple processes and threads by processing data simultaneously. The speed and efficiency of the live-interaction content control logic (200) is greatly improved by instantiating more than one process to instantiate the video-conference between the user and the ad representative (150). However, one skilled in the art of programming will appreciate that use of a single processing thread may also be utilized and is within the scope of the present invention.

The live-interaction content control logic (200) process flow of the present embodiment begins at step 202, where advertisements related to a search term are received. In one embodiment, the advertisement contains contact information for the advertiser. The contact information can include entries such as an advertisement identification number, a call center identification number, a call center representative identification number, and other suitable contact information. The logic then proceeds to 204.

At step 204, a live-interaction content icon is disposed proximate the advertisement. In one embodiment, the user can mouse-over or select the live-interaction content icon associated with the ad of interest. The logic then proceeds to 206.

At step 206, a video-conference is instantiated between the user and the call center (140) using the call center identification number associated with the ad. In one embodiment, a video-conference is instantiated between the user and the ad representative (150) using the ad representative identification number associated with the ad. The logic then proceeds to 208.

At step 208, it is determined whether the ad representative (150) is available. If the ad representative (150) is not available, the logic proceeds to step 212. If the ad representative (150) is available, the logic proceeds to step 210.

At step 212, content such as a commercial or an image associated with the ad is displayed if the ad representative (150) is not available. In one embodiment, the ad's information contains a URL to a video commercial to be played if there is no ad representative (150) associated with the ad or the ad representative (150) associated with the ad is unavailable. In a second embodiment, the ad's information contains a URL, to an image to be displayed if there is no ad representative (150) associated with the ad or the ad representative (150) associated with the ad is unavailable. In a third embodiment, the image is a brand or logo associated with the product, service, or advertiser listed in the ad. In a fourth embodiment, the ad representative can be the advertiser. In a fifth embodiment, the ad representative can be a third party determined by the advertiser. In a sixth embodiment, the call center can be the advertiser. If the ad does not have an ad representative (150) listed, the method terminates. If the ad does have an ad representative (150) listed, the logic proceeds to 208.

At step 210, the video-conference is displayed to the user if the ad representative (150) is available. In one embodiment, the ad representative (150) pops up in the first pop-up window, greets the user, provides information about the advertised product or service, and answers any questions the user may have about the product or service. The logic then proceeds to 214.

At step 214, it is determined whether the ad representative (150) desires to display additional content to the user. If the ad representative (150) does not desire to display additional content to the user, the logic proceeds to step 210. If the ad representative (150) desires to display additional content to the user, the logic proceeds to step 216.

At step 216, the additional content is displayed to the user. In one embodiment, the ad representative (150) can transmit additional content, such as a video, audio, image, document, web form, and other suitable digital content, for display in the second pop-up window for the user to evaluate or complete and submit. The logic then proceeds to 218.

At step 218, it is determined whether the video-conference has concluded. If the video-conference has not concluded, the logic proceeds to step 210. If the video-conference has concluded, the logic proceeds to step 220.

At step 220, the session is terminated, all pop-up windows close, and the user can continue his search.

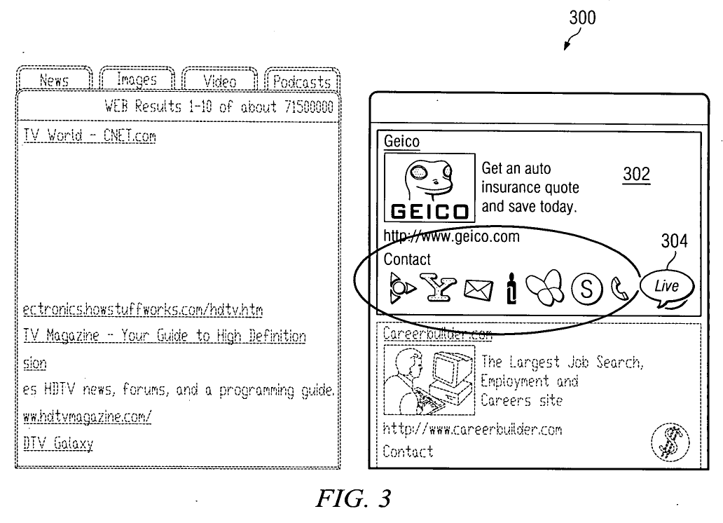

Referring now to FIG. 3, there is shown at 300 a screen shot of a web-browser (110) rendering an advertisement (302) and a live-interaction content icon (304) associated with the advertisement, in accordance with principles of the present invention. The live-interaction content icon (304) can trigger the instantiation of a live-interaction session between the user and the ad representative by mousing-over the live-interaction content icon (304) or by selecting the live-interaction content icon (304).

The invention may be embodied in other specific forms without departing from the spirit or essential characteristics thereof. The present embodiments are therefore to be considered in all respects as illustrative and not restrictive. Accordingly, the scope of the invention is established by the appended claims rather than by the foregoing description. All changes which come within the meaning and range of equivalency of the claims are therefore intended to be embraced therein. Further, the recitation of method steps does not denote a particular sequence for execution of the steps. Such method steps may therefore be performed in a sequence other than that recited unless the particular claim expressly states otherwise.

I claim:

1. A method for providing, in a networked environment, live interaction between a user and an advertiser or the advertiser's designated representative through the user's HTML browser, wherein the user's browser displays at least one advertisement, the method steps comprising:
providing a live interaction icon for at least one advertisement, wherein the icon is located proximate the advertisement, and wherein the icon is capable of providing an indication of the user's desire to obtain information regarding the advertisement;
accepting a request from the user via the live interaction icon;
initiating a video-conference session between the user and the advertiser or the advertiser's designated representative, wherein the session allows live interaction between the user and the representative; and
providing additional content for display in the user's browser, wherein the additional content provides the user with supplementary information regarding the advertisement.

2. The method of claim 1, the method steps further comprising:
determining whether the advertiser or the advertiser's designated representative is available; and
providing content for display in the user's browser, wherein the content is based upon the aforementioned availability.

3. The method of claim 2, the method steps further comprising:
providing a video commercial to the user in response to the unavailability of the advertiser or the advertiser's designated representative.

4. The method of claim 1, the method steps further comprising:
causing a pop-up window to be instantiated from the user's browser, wherein the video-conference session occurs from the pop-up window.

5. The method of claim 1, the method steps further comprising:
causing a pop-up window to be instantiated from the user's browser, wherein the additional content is displayed in the pop-up window.

6. The method of claim 1, the method steps further comprising:
receiving an advertisement file for display in the user's browser; and
parsing the advertisement file to obtain information regarding the appropriate contact for additional live-interaction information concerning the advertisement.

7. The method of claim 1, wherein the video-conference session consists of streaming video, and the audio portion is conveyed via a phone connection.

8. A computer software program tangibly embodied in a computer readable medium, the program including machine-readable instructions executable by a computer processor to perform a method for providing, in a networked environment, live interaction between a user and an advertiser or the advertiser's designated representative through the user's HTML browser, wherein the user's browser displays at least one advertisement, the program steps comprising:
providing a live interaction icon for at least one advertisement, wherein the icon is located proximate the advertisement, and wherein the icon is capable of providing an indication of the user's desire to obtain information regarding the advertisement;
accepting a request from the user via the live interaction icon;
initiating a video-conference session between the user and the advertiser or the advertiser's designated representative, wherein the session allows live interaction between the user and the representative; and
providing additional content for display in the user's browser, wherein the additional content provides the user with supplementary information regarding the advertisement.

9. The computer software program of claim 8, the program steps further comprising:
determining whether the advertiser or the advertiser's designated representative is available; and
providing content for display in the user's browser, wherein the content is based upon the aforementioned availability.

10. The computer software program of claim 9, the program steps further comprising:
providing a video commercial to the user in response to the unavailability of the advertiser or the advertiser's designated representative.

11. The computer software program of claim 8, the program steps further comprising:
causing a pop-up window to be instantiated from the user's browser, wherein the video-conference session occurs from the pop-up window.

12. The computer software program of claim 8, the program steps further comprising:
causing a pop-up window to be instantiated from the user's browser, wherein the additional content is displayed in the pop-up window.

13. The computer software program of claim 8, the program steps further comprising:
receiving an advertisement file for display in the user's browser; and
parsing the advertisement file to obtain information regarding the appropriate contact for additional live-interaction information concerning the advertisement.

14. The computer software program of claim 8, wherein the video-conference session consists of streaming video, and the audio portion is conveyed via a phone connection.

15. A system for providing, in a networked environment, live interaction between a user and an advertiser or the advertiser's designated representative through the user's HTML browser, wherein the user's browser displays at least one advertisement, the system comprising:
an advertisement contact module, wherein the advertisement contact module parses received advertisement data to obtain contact information for the advertiser or the advertiser's designated representative;
a video-conferencing module, wherein the video-conferencing module establishes a communication session between the user and the advertiser or the advertiser's designated representative; and
a content-rendering module, wherein the content rendering module prepares additional content for display in the user's browser, wherein the additional content is based upon the advertisement.

16. The system of claim 15 wherein the content-rendering module causes the additional content to be displayed to the user in a pop-up window relative to the user's browser.
